(19) United States
(12) Patent Application Publication
(10) Pub. No.: US 2012/0176023 A1
(43) Pub. Date: Jul. 12, 2012

(54) Field emission lamp

(75) Inventor: Tzung-Han Yang, Taipei (TW)

(73) Assignee: Tatung Company, Taipei (TW)

(21) Appl. No.: 13/064,744

(22) Filed: Apr. 13, 2011

(30) Foreign Application Priority Data
Jan. 6, 2011 (TW) 100100506

(51) Int. Cl. H01J 63/04

(52) U.S. Cl. 313/495

(57) ABSTRACT

A field emission lamp, capable of increasing the number of electron emitting points thereof, and of increasing the uniformity and the intensity of the light output therefrom by installing a lens unit is disclosed. The field emission lamp comprises: an outer shell having an inner surface, an anode portion formed on a portion of the inner surface of the outer shell, a cathode portion surrounded by the outer shell, a phosphor layer formed on a portion of the anode portion, and a lens unit disposed adjacent to the inner surface of the outer shell where the anode portion is not formed. Wherein, the phosphor layer generates light due to the bombardment of the electrons, the light passes through the lens unit and the inner surface of the outer shell where the anode portion is not formed, and outputs from the field emission lamp.

### CROSS REFERENCE TO RELATED APPLICATION

This application claims the benefits of the Taiwan Patent Application Ser. No. 100100506, filed on Jan. 6, 2011, the subject matter of which is incorporated herein by reference.

### BACKGROUND OF THE INVENTION

1. Field of the Invention

The present invention relates to a field emission lamp and, more particularly, to a field emission lamp capable of increasing the uniformity of the light output therefrom by installing a lens unit, and of forming an anode portion on a portion of the inner surface of the outer shell thereof.

2. Description of Related Art

A conventional field emission lamp comprises: a transparent outer shell, an anode portion, a cathode portion, and a phosphor layer. The anode portion and the phosphor layer are formed on an inner surface of the transparent outer shell in sequence. The cathode portion is installed on a central position inside the transparent outer shell. Besides, the operation mechanism of the conventional field emission lamp is: electrons is emitted from the cathode portion, being accelerated by the high potential of the anode portion, then being collided with the phosphor layer formed on the anode portion. At this time, the light generated by the phosphor layer, due to the bombardment of the electrons, must passes through the phosphor layer, the anode portion, and the transparent outer shell, before being output to the exterior of the conventional field emission lamp, for the purpose of illumination.

However, in the conventional field emission lamp, the light emitted caused by the electrons bombard the phosphor layer is dot-like light emission, so it would display a non-uniform light emission phenomenon if the density of the dot-like light is not greater enough. Therefore, while the conventional field emission lamp is under operation, the light emitted from the conventional field emission lamp is always not uniform enough, constraining the usage of the conventional field emission lamp.

Therefore, a field emission lamp capable of increasing the uniformity of the light output therefrom by installing a lens unit, and of forming an anode portion on a portion of the inner surface of the outer shell thereof is required by the industry.

### SUMMARY OF THE INVENTION

It is one object of the present invention to provide a field emission lamp capable of increasing the uniformity of the light output therefrom by installing a lens unit.

It is another object of the present invention to provide a field emission lamp by means of forming an anode portion on a portion of the inner surface of the outer shell thereof to form the field emission lamp.

To achieve the object, the field emission lamp of the present invention comprises: an outer shell having an inner surface; an anode portion formed on a portion of the inner surface of the outer shell; a cathode portion surrounded by the outer shell; a phosphor layer formed on a portion of the surface of the anode portion; and a lens unit disposed adjacent to the inner surface of the outer shell where the anode portion is not formed; wherein, the phosphor layer generates light due to the bombardment of the electrons, the light passes through the lens unit and the inner surface of the outer shell where the anode portion is not formed, and outputs from the field emission lamp.

Therefore, since the electron is emitted from the cathode portion of the field emission lamp of the present invention, toward the anode portion thereof, until being collided with the phosphor layer. After that, the phosphor layer bombarded by the electrons generates light, the light passes through the lens unit and the inner surface of the outer shell where the anode portion is not formed, and outputs from the field emission lamp. Further, since the lens unit can adjust the characteristics of the light passed through, for example, the lens unit can be a double convex lens or a plano-convex unit which the convex lens structure having the function of focusing the light, or be a double concave lens or a plano-concave lens which the concave lens structure having the function of dispersing the light. Thus, the uniformity of the light emitted from the field emission lamp of the present invention can be increased, and the field emission lamp of the present invention can provide light for different kinds of purpose depending on the different situation, by using different structure of lens unit.

In addition, the form of the cathode portion of the field emission lamp of the present invention is not limited, the shape thereof can be clavate, or has a curving structure, a spherical structure or a bowl-like structure. Besides, the material of the phosphor layer is not limited, it can be any conventional fluorescent powder, or any conventional phosphor powder suitable for application. Moreover, for different purpose or responding to different requirement, the phosphor layer can be made by mixing one or more kinds of fluorescent powder, or phosphor powder, for emitting UV light, infrared light, white light, or light of other colors. Besides, the form of the lens unit is not limited, any lens unit that can increase the uniformity of the light, or to disperse the light, or to focus the light is suitable for the present invention.

Further, the position of the lens unit of the field emission lamp of the present invention in not limited, it can be disposed inside the field emission lamp of the present invention or to be disposed in the form of micro-lens on the outer surface of the field emission lamp of the present invention. Besides, the material of the anode portion of the field emission lamp of the present invention is not limited, it can be aluminum film, nickel film, gold film, silver film, or tin film.

### BRIEF DESCRIPTION OF THE DRAWINGS

FIG. 1 is a perspective view of the field emission lamp according to first embodiment of the present invention.

FIG. 2 is a perspective view of the field emission lamp according to second embodiment of the present invention.

FIG. 3 is a perspective view of the field emission lamp according to third embodiment of the present invention.

FIG. 4 is a perspective view of the field emission lamp according to fourth embodiment of the present invention.

FIG. 5 is a perspective view of the field emission lamp according to fifth embodiment of the present invention.

FIG. 6 is a perspective view of the field emission lamp according to sixth embodiment of the present invention.

### DETAILED DESCRIPTION OF THE PREFERRED EMBODIMENT

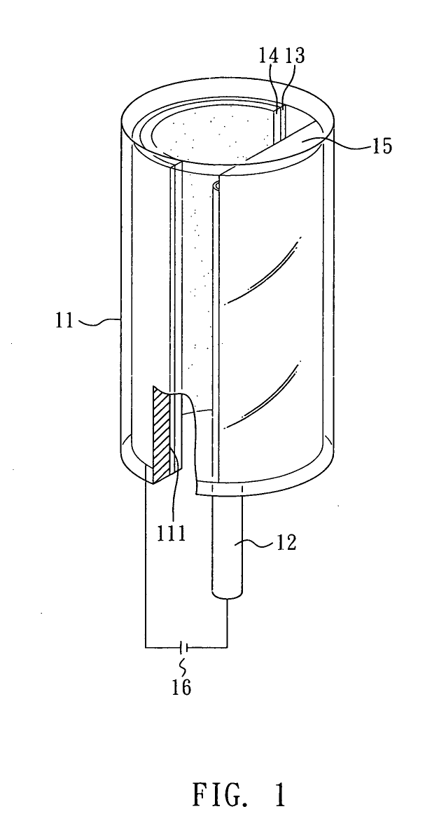

With reference to FIG. 1, FIG. 1 is a perspective view of the field emission lamp according to first embodiment of the present invention. As shown in FIG. 1, the field emission lamp according to first embodiment of the present invention comprises: an outer shell 11, a cathode portion 12, an anode portion 13, a phosphor layer 14, and a lens unit 15. Wherein, the outer shell 11 can be formed by a transparent material, for example, a soda-lime glass. Besides, the material of the outer shell 11 can also be soda glass, boron-glass, flint glass, quartz glass, or alkali-free glass. In addition, the outer shell 11 has an inner surface 111, and the light generated by the phosphor layer 14, due to the bombardment of the electrons, outputs from the field emission lamp according to first embodiment of the present invention through the lens unit 15, and the inner surface 111 of the outer shell 11 where the anode portion 13 is not formed.

Moreover, the shape of the outer shell 11 is tubular, and the cathode portion 12 is surrounded by the outer shell 11. It should be noticed that, the position of the cathode portion 12 is not limited, except for being positioned at the interior of the outer shell 11, and not being directly contacted to the phosphor layer 14, the lens unit 15, or the outer shell 11. On the other hand, in the present embodiment, the shape of the cathode portion 12 is clavate and the material thereof is metal.

Besides, the anode portion 13 is formed on half of the inner surface 111 of the outer shell 11, as shown in FIG. 1. That is, central angle included by the portion where the anode portion 13 is formed thereon is 180 degrees. However, in other application circumstances, the central angle included by the portion where the anode portion 13 is formed thereon maybe other degrees, for example, between 30 degrees and 210 degrees. In addition, the anode portion 13 is a metallic film, for example, aluminum film, nickel film, gold film, silver film, or tin film. At final, the phosphor layer 14 is formed on portions of the surface of the anode portion 13 by spin-coating, for receiving the bombardment of electrons to generate light.

Further, the lens unit 15 is disposed adjacent to the inner surface 111 of the outer shell 11 where the anode portion 13 is not formed, and as shown in FIG. 1, in the field emission lamp according to first embodiment of the present invention, the lens unit 15 is surrounded by the outer shell 11. It should be noticed that, the form of the lens unit 15 is not limited, so that any lens unit that can increase the uniformity of the light, or to disperse the light, or to focus the light is suitable for the field emission lamp according to first embodiment of the present invention.

Please refer to FIG. 1 again, after a power source 16 is connected with the anode portion 13 and the cathode portion 12 of the field emission lamp according to first embodiment of the present invention, electrons (not shown in the figure) emits from the cathode portion 12 and collides with the phosphor layer 14 formed on portions of the surface of the anode portion 13 for generating light. In addition, as the anode portion 13 is made of metal, the light generated is reflected by the anode portion 13. Then, after passing through the lens unit 15, the reflected light outputs from the field emission lamp according to first embodiment of the present invention through then lens unit 15, and then the inner surface 111 of the outer shell 11 where the anode portion 13 is not formed.

As described above, since in the foresaid light output process, the light will passes through the lens unit 15, so the intensity distribution of the light becomes more uniform, or turns to the purpose of focusing or dispersing the light, to provide a more expansive lighting area and a more uniform lighting intensity. On the other hand, since the light generated, due the electrons bombarded, by the phosphor layer needs not to pass through any anode portion or phosphor layer before outputting from the field emission lamp according to first embodiment of the present invention, so that the losses caused by passing through the anode portion and the phosphor layer can be avoided. Therefore, the lighting efficiency of the field emission lamp according to first embodiment of the present invention can be increased substantially.

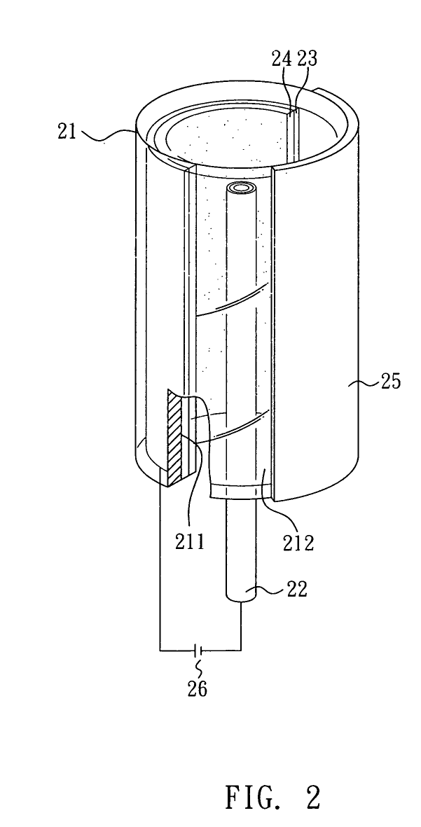

With reference to FIG. 2, wherein FIG. 2 is a perspective view of the field emission lamp according to second embodiment of the present invention. As shown in FIG. 2, the field emission lamp according to second embodiment of the present invention comprises: an outer shell 21, a cathode portion 22, an anode portion 23, a phosphor layer 24, and a lens unit 25. Wherein, the outer shell 21 can be formed by a transparent material, for example, a soda-lime glass. Besides, the material of the outer shell 21 can also be soda glass, boron-glass, flint glass, quartz glass, or alkali-free glass. In addition, the outer shell 21 has an inner surface 211 and an outer surface 212, and the light generated by the phosphor layer 24, due to the bombardment of the electrons, outputs from the field emission lamp according to second embodiment of the present invention through the inner surface 211 of the outer shell 21 where the anode portion 23 is not formed, and the lens unit 25.

Moreover, in the present embodiment, the shape of the outer shell 21 is tubular, and the cathode portion 22 is surrounded by the outer shell 21. It should be noticed that, the position of the cathode portion 22 is not limited, except for being positioned at the interior of the outer shell 21, and not being directly contacted to the phosphor layer 24, or the outer shell 21. On the other hand, in the present embodiment, the shape of the cathode portion 22 is clavate and the material thereof is metal.

Besides, the anode portion 23 is formed on half of the inner surface 211 of the outer shell 21, as shown in FIG. 2. That is, central angle included by the portion where the anode portion 23 is formed thereon is 180 degrees. However, in other application circumstances, the central angle included by the portion where the anode portion 23 is formed thereon maybe other degrees, for example, between 30 degrees and 210 degrees. In addition, the anode portion 23 is a metallic film, for example, aluminum film, nickel film, gold film, silver film, or tin film. Further, the phosphor layer 24 is formed on portions of the surface of the anode portion 23 by spin-coating, for receiving the bombardment of electrons to generate light.

At final, the lens unit 25 is disposed adjacent to the inner surface 211 of the outer shell 21 where the anode portion 23 is not formed. Actually, as shown in FIG. 2, in the field emission lamp according to second embodiment of the present invention, the lens unit 25 is disposed on the outer surface 212 of the outer shell 21(corresponding to the foresaid inner surface 211 where the anode portion 23 is not formed). It should be noticed that, in the present embodiment, the form of the lens unit 25 is not limited, any lens unit that can increase the uniformity of the light, or to disperse the light, or to focus the light is suitable for the field emission lamp according to second embodiment of the present invention, such as a thin micro-lens film.

Please refer to FIG. 2 again, after a power source 26 is connected with the anode portion 23 and cathode portion 22 of the field emission lamp according to second embodiment of the present invention, electrons (not shown in the figure) emits from the cathode portion 22 and collides with the phosphor layer 24 formed on portions of the surface of the anode portion 23 for generating light. In addition, as the anode portion 23 is made of metal, the light generated is further reflected by the anode portion 23. Then, the reflected light outputs from the field emission lamp according to second embodiment of the present invention through the inner surface 211 of the outer shell 21 where the anode portion 23 is not formed, and then the lens unit 25.

As described above, since in the foresaid light output process, the light will passes through the lens unit 25, so the intensity distribution of the light becomes more uniform or turns to the purpose of focusing or dispersing the light, to provide a more expansive lighting area and a more uniform lighting intensity. On the other hand, since the light generated, due the electrons bombarded, by the phosphor layer needs not to pass through any anode portion or phosphor layer before outputting from the field emission lamp according to first embodiment of the present invention, so that the losses caused by passing through the anode portion and the phosphor layer can be avoided. Therefore, the lighting efficiency of the field emission lamp according to first embodiment of the present invention can be increased substantially.

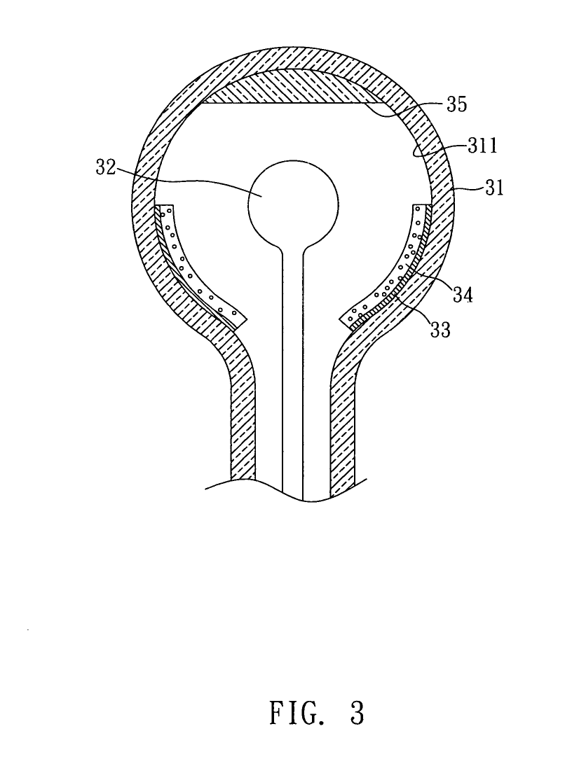

With reference to FIG. 3, the field emission lamp according to third embodiment of the present invention comprises: an outer shell 31, a cathode portion 32, an anode portion 33, phosphor layer 34, and a lens unit 35. Wherein, the outer shell 31 can be formed by a transparent material, for example, a soda-lime glass. Besides, the material of the outer shell 31 can also be soda glass, boron-glass, flint glass, quartz glass, or alkali-free glass.

In addition, the outer shell 31 has an inner surface 311, and the light generated by the phosphor layer 34, due to the bombardment of the electrons, outputs from the field emission lamp according to third embodiment of the present invention through the lens unit 35, and then the inner surface 311 of the outer shell 31 where the anode portion 33 is not formed.

Moreover, in the present embodiment, the outer shell 31 is a bulb-like shell, and the cathode portion 32 is surrounded by the outer shell 31. It should be noticed that, the position of the cathode portion 32 is not limited, except for being positioned at the interior of the outer shell 31, and not being directly contacted to the phosphor layer 34, the lens unit 35, or the outer shell 31. On the other hand, in the present embodiment, the shape of the cathode portion 32 is sphere and the material thereof is metal.

In addition, the anode portion 33 is formed on a portion of the inner surface 311 of the outer shell 31, as the aspect shown in FIG. 3. Further, the material of the anode portion 33 is metallic film, for example, aluminum film, nickel film, gold film, silver film, or tin film. At final, the phosphor layer 34 is formed on portions of the surface of the anode portion 33 by spin-coating, for receiving the bombardment of electrons to generate light.

At final, the lens unit 35 is disposed adjacent to the inner surface 311 of the outer shell 31 where the anode portion 33 is not formed. And, as shown in FIG. 3, the lens unit 35 is surrounded by the outer shell 31 in the field emission lamp according to third embodiment of the present invention.

As the structure of the field emission lamp according to third embodiment of the present invention is similar to that of the field emission lamp according to first embodiment of the present invention, and the only difference between them are: the shape of the outer shell (tubular vs. bulb-like shape) and the shape of the cathode portion (clavate vs. spherical), the detail description regarding the operation of the field emission lamp according to third embodiment of the present invention, such as the mechanism of the generation of light, is omitted hereinafter.

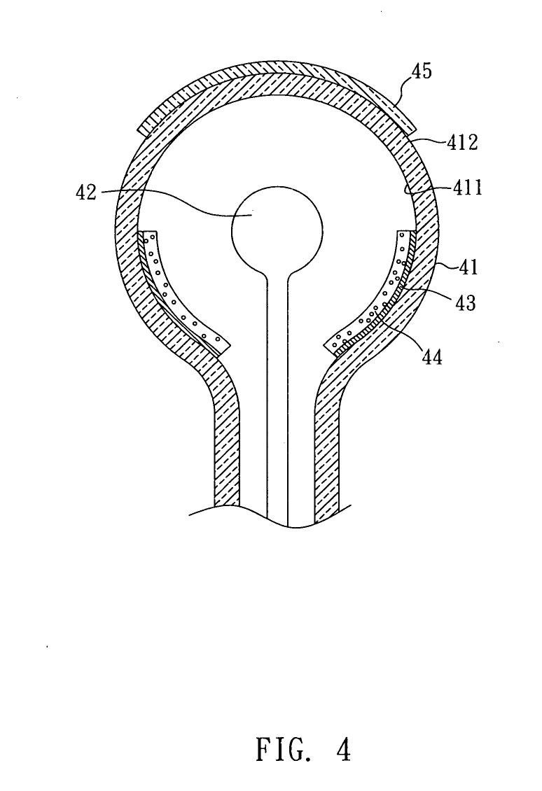

With reference to FIG. 4, the field emission lamp according to fourth embodiment of the present invention comprises: an outer shell 41, a cathode portion 42, an anode portion 43, phosphor layer 44, and a lens unit 45. Wherein, the outer shell 41 can be formed by a transparent material, for example, a soda-lime glass. Besides, the material of the outer shell 41 can also be soda glass, boron-glass, flint glass, quartz glass, or alkali-free glass. In addition, the outer shell 41 has an inner surface 411, and the light generated by the phosphor layer 44, due to the bombardment of the electrons, outputs from the field emission lamp according to fourth embodiment of the present invention through the inner surface 411 of the outer shell 41 where the anode portion 43 is not formed, and then the lens unit 45.

Moreover, in the present embodiment, the outer shell 41 is a bulb-like shell, and the cathode portion 42 is surrounded by the outer shell 41. It should be noticed that, the position of the cathode portion 42 is not limited, except for being positioned at the interior of the outer shell 41, and not being directly contacted to the phosphor layer 34, the lens unit 45, or the outer shell 41. On the other hand, in the present embodiment, the shape of the cathode portion 42 is sphere and the material thereof is metal.

In addition, the anode portion 43 is formed on a portion of the inner surface 411 of the outer shell 41, as the aspect shown in FIG. 4. Further, the material of the anode portion 43 is metallic film, for example, aluminum film, nickel film, gold film, silver film, or tin film. At final, the phosphor layer 44 is formed on portions of the surface of the anode portion 43 by spin-coating, for receiving the bombardment of electrons to generate light.

At final, the lens unit 45 is disposed adjacent to the inner surface 411 of the outer shell 41 where the anode portion 43 is not formed. Actually, as shown in FIG. 4, of the field emission lamp of the fourth embodiment of the present invention, the lens unit 45 is disposed on the outer surface 412 of the outer shell 41(corresponding to the foresaid inner surface 411 where the anode portion 43 is not formed).

As the structure of the field emission lamp according to fourth embodiment of the present invention is similar to that of the field emission lamp according to second embodiment of the present invention, and the only difference between them are: the shape of the outer shell (tubular vs. bulb-like shape) and the shape of the cathode portion (clavate vs. spherical), the detail description regarding the operation of the field emission lamp according to fourth embodiment of the present invention, such as the mechanism of the generation of light, is omitted hereinafter.

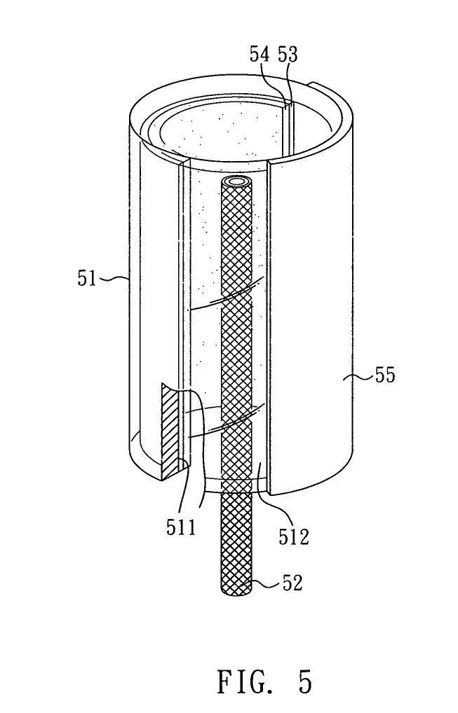

With reference to FIG. 5, wherein FIG. 5 is a perspective view of the field emission lamp according to fifth embodiment of the present invention.

The field emission lamp according to fifth embodiment of the present invention comprises: an outer shell 51, a cathode portion 52, an anode portion 53, phosphor layer 54, and a lens unit 55. Wherein, the outer shell 51 can be formed by a transparent material, for example, a soda-lime glass. Besides, the outer shell 51 has an inner surface 511, and the light generated by the phosphor layer 54, due to the bombardment of the electrons, outputs from the field emission lamp according to fifth embodiment of the present invention through the inner surface 511 of the outer shell 51 where the anode portion 53 is not formed, and then the lens unit 55. In addition, in the present embodiment, the cathode portion 52 is a mesh-type cathode portion for increasing the number of electron emitting points thereof, to further increase the uniformity and the intensity of the light output from the field emission lamp according to fifth embodiment of the present invention.

Further, the lens unit 55 is disposed adjacent to the inner surface 511 of the outer shell 51 where the anode portion 53 is not formed. Actually, as shown in FIG. 5, in the field emission lamp according to the fifth embodiment of the present invention, the lens unit 55 is disposed on the outer surface 512 of the outer shell 51(corresponding to the foresaid inner surface 511 where the anode portion 53 is not formed). It should be noticed that, in the present embodiment, the form of the lens unit 55 is not limited, any lens unit that can increase the uniformity of the light, or to disperse the light, or to focus the light is suitable for the field emission lamp according to fifth embodiment of the present invention, such as a thin micro-lens film. In addition, the lens unit 55 can be a double convex lens or a plano-convex unit which the convex lens structure having the function of focusing the light, or be a double concave lens or a plano-concave lens which the concave lens structure having the function of dispersing the light. Thus, the uniformity of the light emitted from the field emission lamp of the present invention can be increased, and the field emission lamp of the present invention can provide light for different kinds of purpose by using different structure of lens unit. One another aspect of the present embodiment, the lens unit 55 is disposed on the inner surface 511 of the outer shell 51 where the anode portion 53 is not formed.

As the structure of the field emission lamp according to fifth embodiment of the present invention is similar to that of the field emission lamp according to first embodiment of the present invention, and the only difference between them is the form of the cathode portion, the detail description regarding the operation of the field emission lamp according to fifth embodiment of the present invention, such as the mechanism of the generation of light, is omitted hereinafter.

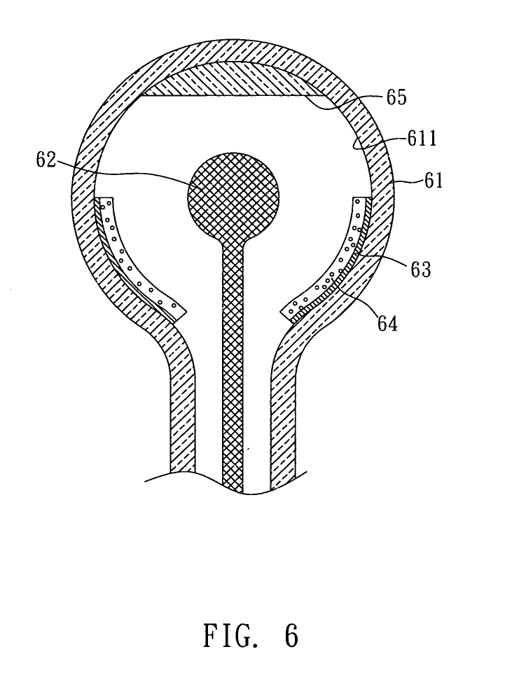

With reference to FIG. 6, wherein FIG. 6 is a perspective view of the field emission lamp according to sixth embodiment of the present invention. The field emission lamp according to sixth embodiment of the present invention comprises: an outer shell 61, a cathode portion 62, an anode portion 63, a phosphor layer 64, and a lens unit 65. Wherein, the outer shell 61 can be formed by a transparent material, for example, a soda-lime glass. Besides, the material of the outer shell 61 can also be soda glass, boron-glass, flint glass, quartz glass, or alkali-free glass. In addition, the outer shell 61 has an inner surface 611, and the light generated by the phosphor layer 64, due to the bombardment of the electrons, outputs from the field emission lamp according to sixth embodiment of the present invention through the lens unit 65, and then the inner surface 611 of the outer shell 61, where the anode portion 63 is not formed. In addition, in the present embodiment, the cathode portion 62 is a mesh-type cathode portion for increasing the number of electron emitting points thereof, to further increase the uniformity and the intensity of the light output from the field emission lamp according to sixth embodiment of the present invention.

Further, the lens unit 65 is disposed adjacent to the inner surface 611 of the outer shell 61 where the anode portion 63 is not formed. As shown in FIG. 6, in the field emission lamp according to the sixth embodiment of the present invention, the lens unit 65 is surrounded by the outer shell 61. It should be noticed that, in the present embodiment, the form of the lens unit 65 is not limited, any lens unit that can increase the uniformity of the light, or to disperse the light, or to focus the light is suitable for the field emission lamp according to sixth embodiment of the present invention. In addition, the lens unit 65 can be a double convex lens or a plano-convex unit which the convex lens structure having the function of focusing the light, or be a double concave lens or a plano-concave lens which the concave lens structure having the function of dispersing the light. Thus, the uniformity of the light emitted from the field emission lamp of the present invention can be increased, and the field emission lamp of the present invention can provide light for different kinds of purpose by using different structure of lens unit. One another aspect of the present embodiment, the lens unit 65 is disposed on the outer surface of the outer shell 61.

As the structure of the field emission lamp according to sixth embodiment of the present invention is similar to that of the field emission lamp according to third embodiment of the present invention, and the only difference between them is the form of the cathode portion, the detail description regarding the operation of the field emission lamp according to sixth embodiment of the present invention, such as the mechanism of the generation of light, is omitted hereinafter.

Although the present invention has been explained in relation to its preferred embodiments, it is to be understood that many other possible modifications and variations can be made without departing from the scope of the invention as hereinafter claimed.

1. A field emission lamp comprising:
an outer shell having an inner surface;
an anode portion formed on a portion of the inner surface of the outer shell;
a cathode portion surrounded by the outer shell;
a phosphor layer formed on a portion of the surface of the anode portion; and
a lens unit disposed adjacent to the inner surface of the outer shell where the anode portion is not formed;
wherein, the phosphor layer generates light due to the bombardment of the electrons, the light passes through the lens unit and the inner surface of the outer shell where the anode portion is not formed, and outputs from the field emission lamp
wherein the material of the outer shell is soda-lime glass, soda glass, boron-glass, flint glass, quartz glass, or alkali-free glass.

2. (canceled)

3. The field emission lamp as claimed in claim 1, wherein the shape of the outer shell is tubular.

4. The field emission lamp as claimed in claim 3, wherein the shape of the cathode portion is clavate.

5. The field emission lamp as claimed in claim 3, wherein the lens unit is surrounded by the outer shell.

6. The field emission lamp as claimed in claim 3, wherein the lens unit is disposed on an outer surface of the outer shell.

7. The field emission lamp as claimed in claim 1, wherein the outer shell is a bulb-like shell.

8. The field emission lamp as claimed in claim 7, wherein the shape of the cathode portion is sphere.

9. The field emission lamp as claimed in claim 7, wherein the lens unit is surrounded by the outer shell.

10. The field emission lamp as claimed in claim 7, wherein the lens unit is disposed on an outer surface of the outer shell.

11. The field emission lamp as claimed in claim 1, wherein the anode portion is a metallic film.

12. The field emission lamp as claimed in claim 11, wherein the metallic film is aluminum film, nickel film, gold film, silver film, or tin film.
